(19) United States
(12) Patent Application Publication
(10) Pub. No.: US 2012/0026580 A1
(43) Pub. Date: Feb. 2, 2012

(54) INFRARED LIGHT REFLECTIVE FILM

(76) Inventor: Naoharu KIYOTO, Ashigarakami-gun (JP)

(21) Appl. No.: 13/191,533

(22) Filed: Jul. 27, 2011

(30) Foreign Application Priority Data
Jul. 28, 2010 (JP) 2010-169752

(51) Int. Cl. G02B 5/28

(52) U.S. Cl. 359/359

(57) ABSTRACT

An infrared light reflective film comprising a dielectric multi-layered film constituted of an alternate laminate of a low-refractive index dielectric layer and a high-refractive index dielectric layer and a cholesteric liquid crystal-containing infrared light reflective layer, wherein all of the dielectric layers are composed of an inorganic material other than a metal and satisfy 225 nm≦ni×di≦350 nm in which ni represents a refractive index of an i-th dielectric layer and di represents a thickness of an i-th dielectric layer.

### CROSS-REFERENCE TO RELATED APPLICATION

The present application claims the benefit of priority from Japanese Patent Application No. 2010-169752, filed on Jul. 28, 2010, the contents of which are herein incorporated by reference in their entirety.

### BACKGROUND OF THE INVENTION

1. Field of the Invention

The present invention relates to an infrared light reflective film having an infrared light reflective layer composed of plural layers having a cholesteric liquid crystal phase immobilized therein, in particular an infrared light reflective film to be stuck onto a building window, an automobile window or the like.

2. Description of the Related Art

In recent years, in view of a growing interest in the environment or energy, needs for industrial products regarding conservation of energy are increasing. As one of such needs, glasses or films which are effective for shielding the heat of window glasses of a house, an automobile or the like, namely for reducing a heat load by sunlight, are demanded. In order to reduce the heat load by sunlight, it is necessary to prevent transmission of solar rays in any one of a visible light region or an infrared region of solar spectrum. In the house, in general, since high visible light transmission properties are demanded, it is required to reflect infrared rays. In particular, for automobile windows, a high transmittance in a visible light region is required from the standpoint of safety.

Here, there is proposed a method of utilizing a cholesteric light crystal phase as a material having properties of reflecting a light in a specified transmission wavelength band, such as infrared rays but transmitting an unintended light such as a visible light. For example, in an image display device, JP-A-2003-294940 discloses an optical film having an inorganic multi-layered film and a cholesteric liquid crystal layer as an optical film for transmitting a light in a specified transmission wavelength band. As a method of positively utilizing such a cholesteric liquid crystal phase as an infrared light reflective layer, for example, JP-A-4-281403 discloses an infrared light reflective laminate having an inorganic single-layered film and plural cholesteric liquid crystal phases. Also, JP-T-2009-514022 discloses an infrared light reflective article having an organic multi-layered film as an alternate layer composed of a first polymer type and a second polymer type and a cholesteric liquid crystal layer; an infrared light reflective article in which a layer (single layer) containing nano particles is disposed adjacent to an infrared light reflective cholesteric liquid crystal layer; an infrared light reflective article in which a metal layer is disposed adjacent to an infrared light reflective cholesteric liquid crystal layer; and the like.

Meanwhile, there is also known a method for achieving heat shielding or thermal insulation as a technique which is not distinctly distinguished from the method of preventing transmission of solar rays in any one of a visible light region or an infrared region of solar spectrum, but is similar thereto. A multi-layered glass in which a special metal film capable of shielding thermal radiation is coated and which is called a “Low-E pair glass” is frequently used as an eco-glass having high thermal insulation or heat shielding properties. The special metal film can be, for example, prepared by laminating plural layers by a vacuum film forming method. However, when the metal film is used in a layer constituting a building window, an automobile window or the like, it also shields a radio wave at the same time. Therefore, there are involved such problems that when used for a house, mobile phones or the like cause electromagnetic interference and are hardly usable, whereas when used for an automobile, ETC is not usable. Also, not only an improvement of the electromagnetic interference but when used for an automobile window, visible light transmission on a higher level from the viewpoint of safety was demanded.

As an example of utilizing a combination of a metal film and a cholesteric liquid crystal phase for an infrared light reflective film, there are known a filter for plasma display capable of shielding infrared rays by laminating a layer composed of a metal thin film layer interposed by two metal oxide transparent coating agent layers, a film base material and a cholesteric liquid crystal layer in this order; and so on (see, for example, JP-A-11-65461).

Furthermore, in the field where a reduction of a heat load by sunlight is required, in particular in the field of heat shielding of window glasses of a house, an automobile or the like, it is also important that even when exposed to direct sunlight over a long period of time, a heat shielding performance or a visible light transmittance does not drop. For that reason, even in the field of an infrared light reflective film utilizing a cholesteric liquid crystal phase, in addition to high visible light transmission properties, heat shielding performance and radio wave transmission properties, it is required that even when utilized over a long period of time, such properties are not deteriorated, namely light resistance is provided.

### SUMMARY OF THE INVENTION

Now, in order to prepare an infrared light reflective film having a high heat shielding performance, it is necessary to make a reflection wavelength band of an infrared light wide. Usually, in order to widen the reflection wavelength band of an infrared light, it is general to take a structure in which plural infrared light reflective films of a cholesteric liquid crystal phase having a different selective reflection wavelength from each other are laminated. However, when the present inventor actually prepared an infrared light reflective film in which plural cholesteric liquid crystal phases are laminated, it was noted that dissatisfaction remains especially from the viewpoint of light resistance. Then, with respect to the infrared light reflective layer of a cholesteric liquid crystal phase having a multi-layered structure, infrared light reflective films having the same constitution were investigated by reference to the constitutions of Patent Documents 1 to 4. As a result, in all of the case of being laminated with an inorganic single-layered film, the case of being laminated with an organic multi-layered film and the case of being laminated with a metal film, it was noted that dissatisfaction remains from the viewpoint of enhancing visible light transmission properties, heat shielding performance, light resistance and radio wave transmission properties at the same time.

In view of the foregoing problems, the invention has been made. That is, a problem to be solved by the invention is to provide an infrared light reflective film including a layer having a cholesteric liquid crystal phase immobilized therein and having high visible light transmission properties, heat shielding performance, light resistance and radio wave transmission properties.

In order to solve the foregoing problem, the present inventor made extensive and intensive investigations. As a result, it has been found that the visible light transmission properties, heat shielding performance, light resistance and radio wave transmission properties can be enhanced at the same time by combining a structure in which a dielectric film composed of a specified inorganic material is laminated in a specified mode, with an infrared light reflective layer of a cholesteric liquid crystal phase. That is, the present inventor has found that the foregoing problem can be solved by the following constitution, leading to accomplishment of the invention. The invention has the following constitution.

[1] An infrared light reflective film comprising a dielectric multi-layered film constituted of an alternate laminate of a low-refractive index dielectric layer and a high-refractive index dielectric layer and a cholesteric liquid crystal-containing infrared light reflective layer, wherein all of the dielectric layers constituting the dielectric multi-layered film are composed of an inorganic material other than a metal, and all of the dielectric layers constituting the dielectric multi-layered film satisfy the following expression (1).

225 nm≦ni×di≦350 nm (1)

In the expression (1), ni represents a refractive index of an i-th dielectric film of the dielectric multi-layered film; and di represents a thickness of an i-th dielectric film of the dielectric multi-layered film.

[2] The infrared light reflective film as set forth in [1], wherein a wavelength of infrared rays to be reflected by the cholesteric liquid crystal-containing infrared light reflective layer includes the range of from 1,300 nm to 1,800 nm.
[3] The infrared light reflective film as set forth in [1] or [2], wherein the cholesteric liquid crystal-containing infrared light reflective layer contains four or more cholesteric liquid crystal layers.
[4] The infrared light reflective film as set forth in any one of [1] to [3], wherein the dielectric films constituting the dielectric multi-layered film are four or more layers.
[5] The infrared light reflective film as set forth in any one of [1] to [4], wherein all of the dielectric films constituting the dielectric multi-layered film satisfy the following expression (2).

225 nm≦ni×di≦300 nm (2)

In the expression (2), ni represents a refractive index of an i-th dielectric film of the dielectric multi-layered film; and di represents a thickness of an i-th dielectric film of the dielectric multi-layered film.

[6] The infrared light reflective film as set forth in any one of [1] to [5], wherein a total film thickness of the dielectric multi-layered film and the cholesteric liquid crystal-containing infrared light reflective layer is from 20 to 40 μm.
[7] The infrared light reflective film as set forth in any one of [1] to [6], wherein a wavelength of infrared rays to be reflected by the dielectric multi-layered film and the cholesteric liquid crystal-containing infrared light reflective layer includes the range of from 900 nm to 1,800 nm.
[8] The infrared light reflective film as set forth in any one of [1] to [7], wherein the dielectric multi-layered film and the cholesteric liquid crystal-containing infrared light reflective layer are adjacent to each other.
[9] The infrared light reflective film as set forth in any one of [1] to [8], wherein the dielectric multi-layered film is formed on a glass substrate.
[10] The infrared light reflective film as set forth in any one of [1] to [9], wherein a visible light transmittance is 70% or more.
[11] The infrared light reflective film as set forth in any one of [1] to [10], wherein a surface resistivity is 1.0×10¹²Ω/□ or more.
[12] The infrared light reflective film as set forth in any one of [1] to [11], which is an infrared light reflective film adhered to window.

According to the invention, it is possible to provide an infrared light reflective film including a layer having a cholesteric liquid crystal phase immobilized therein and having high visible light transmission properties, heat shielding performance, light resistance and radio wave transmission properties.

### BRIEF DESCRIPTION OF DRAWINGS

FIG. 1 is a diagrammatic view illustrating a section of an example of an infrared light reflective film of the invention.

FIG. 2 is a diagrammatic view illustrating a section of another example of an infrared light reflective film of the invention.

FIG. 3 is a graph showing a reflection spectrum of an example of an infrared light reflective film of the invention.

In the drawings, 1 denotes infrared light reflective film, 12 denotes substrate, 14a, 14b, 16a and 16b denote cholesteric liquid crystal-containing infrared light reflective layer, 17 denotes dielectric multi-layered film, 17a denotes low-refractive index dielectric layer and 17b denote high-refractive index dielectric layer.

### BEST MODE FOR CARRYING OUT THE INVENTION

In the following, the contents of the invention are described in detail. In this description, the numerical range expressed by the wording “a number to another number” means the range that falls between the former number indicating the lowermost limit of the range and the latter number indicating the uppermost limit thereof. In this description, “light transmittance” is meant to indicate that the film is transmissive to visible light.

### [Infrared Light Reflective Film]

The infrared light reflective film of the invention comprises a dielectric multi-layered film constituted of an alternate laminate of a low-refractive index dielectric layer and a high-refractive index dielectric layer and a cholesteric liquid crystal-containing infrared light reflective layer, wherein all of the dielectric films constituting the dielectric multi-layered film are composed of an inorganic material other than a metal, and all of the dielectric films constituting the dielectric multi-layered film satisfy the following expression (1).

225 nm≦ni×di≦350 nm (1)

In the expression (1), ni represents a refractive index of an i-th dielectric film of the dielectric multi-layered film; and di represents a thickness of an i-th dielectric film of the dielectric multi-layered film.

The infrared light reflective film of the invention is hereunder described.

### <Constitution>

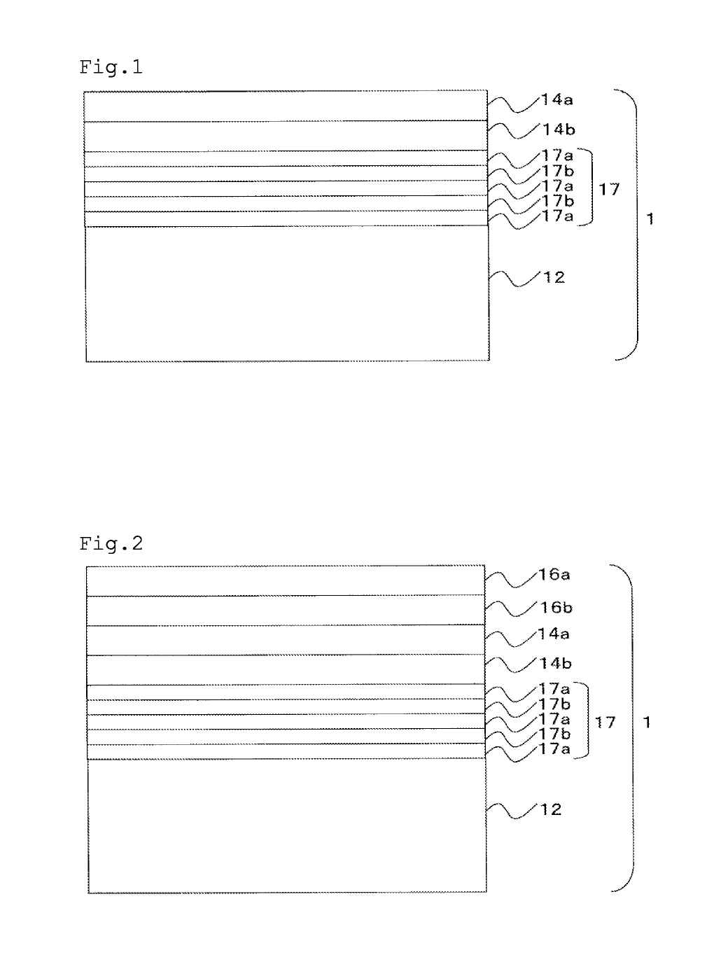

Examples of the infrared light reflective film of the invention are shown in FIGS. 1 and 2, respectively.

An infrared light reflective film 1 shown in FIG. 1 includes a dielectric multi-layered film 17 constituted of an alternate laminate of a low-refractive index dielectric layer 17a and a high-refractive index dielectric layer 17b and a cholesteric liquid crystal-containing infrared light reflective layer 14a (further including 14b in FIG. 1). Also, it is preferable that the dielectric multi-layered film 17 and the cholesteric liquid crystal-containing infrared light reflective layer are adjacent to each other.

The infrared light reflective film of the invention may be used integrally with other supporting member such as a laminated glass. On that occasion, the substrate may be integrated with other supporting member together with the light reflective layer. The light reflective layer may be integrated with the supporting member by separating the substrate. That is, it is preferable that the infrared light reflective film 1 shown in FIGS. 1 and 2 includes a base material 12. It is preferable that the dielectric multi-layered film 17 is formed on the base material 12 (preferably a glass substrate).

Also, it is preferable that the cholesteric liquid crystal-containing infrared light reflective layer includes four or more cholesteric liquid crystal layers. This embodiment is shown in FIG. 2. The infrared light reflective film 1 shown in FIG. 2 is concerned with an embodiment in which light reflective layers 16a and 16b each having a cholesteric liquid crystal phase immobilized therein are further provided on the infrared light reflective film shown in FIG. 1. The infrared light reflective film of the invention is not limited to these embodiments, but an embodiment in which six or more light reflective layers are formed is preferable, too. Meanwhile, the light reflective layer may be formed in an odd number of layers.

### <Dielectric Multi-Layered Film>

The infrared light reflective film of the invention includes a dielectric multi-layered film constituted of an alternate laminate of a low-refractive index dielectric layer and a high-refractive index dielectric layer. Also, all of the dielectric films constituting the dielectric multi-layered film are composed of an inorganic material other than a metal, and all of the dielectric films constituting the dielectric multi-layered film satisfy the following expression (1).

225 nm≦ni×di≦350 nm (1)

In the expression (1), ni represents a refractive index of an i-th dielectric film of the dielectric multi-layered film; and di represents a thickness of an i-th dielectric film of the dielectric multi-layered film.

The invention has one of characteristic features in a point of finding out the fact that the light resistance can be improved by using a cholesteric liquid crystal-containing infrared light reflective layer in combination with the foregoing specified dielectric multi-layered film. Specifically, as a result of investigations made by the present inventor, it was noted that in the cholesteric liquid crystal phase-containing infrared light reflective layer, when exposed to sunlight over a long period of time, various performances are deteriorated. Then, the present inventor made further investigations. As a result, it was noted that the performances tend to be deteriorated by irradiation with an ultraviolet light, and in particular, the deterioration against an ultraviolet light having a wavelength of not more than 380 nm is remarkable. It has been found that by using the foregoing specified dielectric multi-layered film, the light resistance of the cholesteric liquid crystal phase-containing infrared light reflective layer, namely the light resistance as a whole of the infrared light reflective film of the invention, is conspicuously improved, leading to accomplishment of the invention.

In the infrared light reflective film of the invention, all of the dielectric films constituting the dielectric multi-layered film are composed of an inorganic material other than a metal.

In the invention, a transparent dielectric such as TiO₂, Nb₂O₅, Ta₂O₅, SiO₂, Al₂O₃, ZrO₂, MgF₂, ZnS, In₂O₃, MgO, Na₃AlF₆ and CaF₂ can be preferably used for the dielectric film of the film constituted of an alternate laminate of a low-refractive index dielectric layer and a high-refractive index dielectric layer and capable of reflecting infrared rays.

The reason why a multi-layered film composed of a transparent dielectric is used as the infrared light reflective film resides in the matter that when a dielectric having strong absorption in a visible region is used, transmission of the infrared light reflective film in the visible region is low, and visibility cannot be ensured, so that it is difficult to use the film as an opening of window.

Also, when a thin electrically conductive film of every kind, such as metal films and electrically conductive oxide films, is used for the infrared light reflective film, since such a thin conductive film reflects radio waves, it also reflects radio waves used for various communications such as mobile phones, wireless LANs, televisions and radios, thereby giving such an adverse influence that their communication functions are paralyzed. Also, in the case of being used as a window of automobile, not only communication functions using radio waves cannot be used, but giving and receiving of various radio waves taking part in safe driving, such as ETC, GPC and ORBIS, become difficult. For that reason, the infrared light reflective film of the invention uses a laminated film made of dielectrics but not an electrically conductive film as the infrared light reflective film.

In the case of laminating a thin film made of a vapor depositing material, it is more preferable to use, as a high-refractive index material, a metal oxide or a dielectric such as TiO₂, Nb₂O₅, Ta₂O₅, ZrO₂, ZnS and In₂O₃, and it is especially preferable to use TiO₂ or Nb₂O₅. It is more preferable to use, as a low-refractive index material, a metal oxide or a dielectric such as SiO₂, MgF₂, Na₃AlF₆ and CaF₂, and it is especially preferable to use SiO₂.

In the infrared light reflective film of the invention, all of the dielectric films constituting the dielectric multi-layered film satisfy the following expression (1).

225 nm≦ni×di≦350 nm (1)

In the expression (1), ni represents a refractive index of an i-th dielectric film of the dielectric multi-layered film; and di represents a thickness of an i-th dielectric film of the dielectric multi-layered film.

The infrared light reflective film reflects infrared rays by an interference of the laminated dielectric films.

The dielectric multi-layered film constituted of an alternate laminate of a low-refractive index dielectric layer and a high-refractive index dielectric layer has a characteristic of reflecting or transmitting a designed specified wavelength by repeating reflection/interference between thin film layers constituting the low-refractive index dielectric layer and the high-refractive index dielectric layer, respectively.

More specifically, for example, when thin films each having a ¼ wavelength thickness and having a different refractive index from each other are successively laminated on a base material in the order of the low-refractive index layer and the high-refractive index layer from the base material side, a band reflection filter having a high reflectance only in a wavelength range of a band width W centering on its wavelength λ can be made, and the band width W can be determined by a difference in refractive index between the low-refractive index layer and the high-refractive index layer. Also, the reflectance in a reflection wavelength band (wavelength range of the band width W centering on the wavelength λ) is determined by the difference in refractive index and number of laminations, and when the number of laminations increases, it becomes possible to increase the reflectance. From the foregoing viewpoints, the reflection wavelength band of the dielectric multi-layered film and the like are designed.

In the invention, in counting the dielectric multi-layered film constituting the infrared light reflective film from the glass surface, when a maximum value and a minimum value of the refractive index of an even-numbered film are defined as neₘₐₓ and neₘᵢₙ, respectively, and a maximum value and a minimum value of the refractive index of an odd-numbered film are defined as noₘₐₓ and noₘᵢₙ, respectively, from the viewpoint of alternately laminating the low-refractive index dielectric layer and the high-refractive index dielectric layer, it is preferable to regulate the refractive index so as to satisfy a relation of neₘₐₓ<noₘᵢₙ or noₘₐₓ<neₘᵢₙ.

Furthermore, when a refractive index and a thickness of an i-th dielectric film are defined as ni and di, respectively, it is important that an optical path difference (ni×di) relative to infrared rays having a wavelength of from 900 nm to 1,400 nm is ¼ of the wavelength. In consequence, it is desirable that the optical path difference (ni×di) relative to infrared rays having a wavelength in the range of from 900 nm to 1,400 nm is from 900 nm×(¼)=225 nm to 1,400 nm×(¼)=350 nm.

When the dielectric multi-layered film is formed so as to meet the foregoing requirements regarding the refractive index n and the thickness d, a near infrared light reflective film made of a dielectric multi-layered film becomes possible to effectively reflect a light in a wavelength region of from 900 nm to 1,400 nm.

Furthermore, in the infrared light reflective film of the invention, it is more preferable that all of the dielectric films constituting the dielectric multi-layered film satisfy the following expression (2).

225 nm≦ni×di≦300 nm (2)

In the expression (2), ni represents a refractive index of an i-th dielectric film of the dielectric multi-layered film; and di represents a thickness of an i-th dielectric film of the dielectric multi-layered film.

Different from the cholesteric liquid crystal-containing infrared light reflective layer, the dielectric multi-layered film is also able to secondarily reflect a light in a band other than the desired reflection wavelength band. Specifically, the dielectric multi-layered film is able to reflect a light having an optical path difference (ni×di) of (2m+1)/4 times the wavelength (wherein m represents an integer of 0 or more). It is more preferable that the infrared light reflective film of the invention reflects ultraviolet rays by the dielectric multi-layered film, thereby improving the light resistance of the cholesteric liquid crystal phase. Specifically, it is preferable that the optical path difference (ni×di) relative to ultraviolet rays having a wavelength in the range of preferably not more than 400 nm, and more preferably not more than 380 nm is ¾ times the wavelength. In consequence, the optical path difference (ni×di) relative to ultraviolet rays having a wavelength in the range of not more than 380 nm is preferably not more than 400 nm×(¾)=300 nm, and more preferably not more than 380 nm×(¾)=285 nm.

When (ni×di) is not more than 300 nm, a visible light transmittance can be enhanced without reflecting visible rays corresponding to a purple color exceeding a wavelength of 400 nm. Meanwhile, while relating to a shape of a reflection spectrum of the ¼ wavelength by the dielectric multi-layered film (sharpness of a reflection peak), in order that a space may not be formed between a band in which the light can be reflected at a ¼ wavelength by the dielectric multi-layered film and a band in which the light can be reflected by a cholesteric liquid crystal-containing infrared light reflective layer as described later, it is preferable to properly adjust the reflection wavelength of each of them.

In the dielectric multi-layered film, it is preferable that a reflectance of light in the ultraviolet region is high. Specifically, a reflectance of a light of from 300 nm to 380 nm is preferably 30% or more, more preferably 40% or more, and especially preferably 50% or more. Since ultraviolet rays shorter than 300 nm are absorbed by glass, the ultraviolet rays may not be reflected by the dielectric multi-layered film.

Incidentally, in the case where each of the dielectric films of the dielectric multi-layered film is specified only by a film thickness but not (ni×di), the film thickness of each of the dielectric films is preferably from 50 to 350 nm, more preferably from 80 to 300 nm, and especially preferably from 100 to 180 nm.

### (Number of Laminations)

In the infrared light reflective film of the invention, from the viewpoint that reflection in a near infrared region can be enhanced, it is desirable that the number of laminations of the dielectric films constituting the dielectric multi-layered film is 4 or more.

Also, when the layer number increases, not only a maximum value of reflection in an infrared region becomes large, but the color in a visible light region becomes nearly colorless, so that a more favorable near infrared light reflective substrate is produced. However, when the layer number exceeds 12, the manufacturing costs become high. Therefore, in order that a problem in durability may not be caused by an increase of a film stress due to an increase of the film number, the layer number is suitably not more than 11, more preferably not more than 9, and especially preferably not more than 7.

### <Manufacturing Method of Dielectric Multi-Layered Film>

The respective low-refractive index dielectric layer and the respective high-refractive index dielectric layer constituting the dielectric multi-layered film can be prepared by a conventionally known manufacturing method. Specifically, such dielectric films can be prepared by various methods inclusive of a vacuum dry process such as a vacuum vapor deposition method, a sputtering method and an ion plating method and a wet process by coating and in addition thereto, a method of laminating resins, or a method of stretching the laminate, and are not particularly limited with respect to the manufacturing method.

In the case of manufacturing the infrared light reflective film of the invention, it is desirable to adopt a sputtering method capable of undergoing film formation in a uniform film thickness in a large area for lamination of the dielectric multi-layered film.

However, the film formation method is not limited to the sputtering method. A vapor deposition method, an ion plating method, a CVD method, a sol-gel method or the like can also be preferably adopted depending upon the size of the substrate.

The dielectric multi-layered film is formed by superimposing the thus prepared respective low-refractive index dielectric layer and respective high-refractive index dielectric layer (the respective low-refractive index dielectric layer and the respective high-refractive index dielectric layer are prepared so as to have a different reflection wavelength band from each other) and complexing them by, for example, sticking via a pressure-sensitive adhesive or an adhesive or heat fusion (thermal lamination). The dielectric multi-layered film has plural reflection wavelength bands (also have plural transmission wavelength bands) as a whole.

Incidentally, in order that no change of characteristics in the designed reflection wavelength bands may be caused, it is desirable that the multi-layered thin film layers made of the respective low-refractive index dielectric layer and the respective high-refractive index dielectric layer are disposed separately in a thickness to an extent that the light does not interfere (not having coherent properties) or more. However, since a thickness of the pressure-sensitive adhesive or the like, or a thickness of the base material is at least 5 μm or more (usually 20 μm or more), in general, the foregoing problem in the disposition is not caused.

### <Cholesteric Liquid Crystal-Containing Infrared Light Reflective Layer>

### (Constitution of Cholesteric Liquid Crystal-Containing Infrared Light Reflective Layer)

The infrared light reflective film of the invention includes a cholesteric liquid crystal-containing infrared light reflective layer.

In the infrared light reflective film 1 shown in each of FIGS. 1 and 2, the cholesteric liquid crystal-containing infrared light reflective layer immobilizes a cholesteric liquid crystal phase therein, and therefore, the infrared light reflective film 1 exhibits light selective reflection of reflecting a light having a specified wavelength on the basis of a helical pitch of the cholesteric liquid crystal phase. For example, when the adjacent light reflective layers (14a and 14b, or 16a and 16b) have a helical pitch of the same degree and exhibit an optical activity in a reverse direction to each other, any of left and right circular polarizations of a wavelength of the same degree can be reflected, and hence, such is preferable. For example, as an example of the infrared light reflective film 1 shown in FIG. 1, there is exemplified an example in which in the light reflective layers 14a and 14b, the light reflective layer 14a is composed of a liquid crystal composition containing a right handed rotatory chiral agent, whereas the light reflective layer 14b is composed of a liquid crystal composition containing a left handed rotatory chiral agent, and the light reflective layers 14a and 14b have a helical pitch d₁₄ nm of the same degree.

Also, as an example of the infrared light reflective film 1 shown in FIG. 2, there is exemplified an example in which a relation between the light reflective layers 14a and 14b is the same as that in the foregoing example regarding the infrared light reflective film 1; the light reflective layer 16a is composed of a liquid crystal composition containing a right handed rotatory chiral agent, whereas the light reflective layer 16b is composed of a liquid crystal composition containing a left handed rotatory chiral agent; the light reflective layers 16a and 16b have a helical pitch d₁₆ nm of the same degree; and a relation of d₁₄≠d₁₆ is satisfied. The infrared light reflective film 1 satisfying this condition exhibits the same effect as that in the forgoing example regarding the infrared light reflective film 1, and furthermore, the wavelength band of a light to be reflected by the light reflective layers 16a and 16b is expanded, thereby exhibiting light reflection in a wide band.

The infrared light reflective film of the invention exhibits a selective reflection characteristic on the basis of the cholesteric liquid crystal phase of each layer. The infrared light reflective film of the invention may have a layer in which any one of a right-twisted or left-twisted cholesteric liquid crystal phase is immobilized therein. When the infrared light reflective film has a layer having a right-twisted cholesteric liquid crystal phase immobilized therein and a layer having a left-twisted cholesteric liquid crystal phase immobilized therein, respectively, both of which have the same helical pitch, a selective reflectance against a light having a specified wavelength is enhanced, and hence, such is preferable. Also, when the infrared light reflective film has a plurality of a pair of a layer having a right-twisted cholesteric liquid crystal phase immobilized therein and a layer having a left-twisted cholesteric liquid crystal phase immobilized therein, respectively, both of which have the same helical pitch, not only the selective reflectance is enhanced, but the selective reflection wavelength band is made wide, and hence, such is preferable.

Incidentally, a direction of the rotation of the cholesteric liquid crystal phase can be adjusted by the kind of a rod-shaped liquid crystal or the kind of a chiral agent to be added, and the helical pitch can be adjusted by a concentration of such a material.

### (Reflection Wavelength of Cholesteric Liquid Crystal-Containing Infrared Light Reflective Layer)

A selective reflection wavelength of each of the layers of the infrared light reflective film of the invention is not particularly limited. In the infrared light reflective film of the invention, the wavelength of infrared rays to be reflected by the cholesteric liquid crystal-containing infrared light reflective layer includes the range of preferably from 1, 300 nm to 1,800 nm, more preferably from 1, 400 nm to 1,800 nm, and especially preferably from 1, 500 nm to 1,700 nm. However, with respect to wavelengths other than the foregoing band, infrared rays may be reflected. For example, in order that the dielectric multi-layered film may reflect ultraviolet rays as far as possible without reflecting a purple light of visible rays as far as possible, a lower limit value of the wavelength of infrared rays to be reflected by the cholesteric liquid crystal-containing infrared light reflective layer may be 1,200 nm or 1,140 nm.

Also, it is possible to bring a reflection characteristic against the wavelength light overlapping the wavelength light capable of being reflected by the dielectric multi-layered film by adjusting the helical pitch depending upon an application. An example thereof is a so-called infrared light reflective film in which at least one layer reflects a part of light in an infrared light wavelength region with a wavelength of 800 nm or more, whereby heat shielding properties are revealed. In that case, an example of the infrared light reflective film is one capable of reflecting preferably 80% or more, and more preferably 90% or more of sunlight having a wavelength of from 900 nm to 1,160 nm. When a window film is prepared utilizing such a performance, it is possible to achieve a high heat shielding performance such that a shielding coefficient as stipulated in JIS A-5759 (Adhesive films for glazings) is not more than 0.7.

### <Manufacturing Method of Infrared Light Reflective Film>

Next, examples of a material used for the preparation of the infrared light reflective film of the invention and a preparation method thereof are described in detail.

In the infrared light reflective film of the invention, it is preferable to use a curable liquid crystal composition for the formation of the cholesteric liquid crystal-containing infrared light reflective layer. An example of the liquid crystal composition is one containing at least a rod-shaped liquid crystal compound, an optically active compound (chiral agent) and a polymerization initiator. Two or more kinds of each component may be contained. For example, it is possible to use a polymerizable liquid crystal compound and a non-polymerizable liquid crystal compound jointly. Also, it is possible to use a low-molecular weight liquid crystal compound and a high-molecular weight liquid crystal compound jointly. Furthermore, for the purpose of enhancing uniformity of alignment, coating adaptability or film strength, at least one member selected among various additives such as a horizontal alignment agent, an unevenness preventing agent, a repellency preventing agent and a polymerizable monomer may be incorporated. Also, if desired, a polymerization inhibitor, an antioxidant, an ultraviolet absorber, a light stabilizer, a coloring material, a metal oxide fine particle or the like may be added to the liquid crystal composition within the range where the optical performance is not lowered.

Next described are the materials to be contained in the curable liquid crystal composition.

Preferably, the curable liquid crystal composition for forming the light reflective layer contains, for example, at least a rod-shaped liquid crystal compound, an alignment controlling agent capable of controlling the alignment of the rod-shaped liquid crystal compound, and a solvent; and more preferably, the rod-shaped liquid crystal compound is a polymerizable rod-shaped liquid crystal compound.

Also preferably, the curable liquid crystal composition contains at least a rod-shaped liquid crystal compound, an optically-active compound (this may be referred to as a chiral agent), and a polymerization initiator.

More preferably, the composition contains a polymerization initiator. The composition may contain two or more different types of the respective ingredients. For example, both a polymerizable liquid crystal compound and a non-polymerizable liquid crystal compound may be in the composition. Both a low-molecular liquid crystal compound and a high-molecular liquid crystal compound may also be in the composition.

In addition, for the purpose of enhancing the alignment uniformity and the coating aptitude and increasing the film strength, the composition may contain at least one selected from various additives of a horizontal alignment agent, a unevenness inhibitor, a cissing improver, a polymerizable monomer, etc. If desired, a polymerization inhibitor, an antioxidant, a UV absorbent, alight stabilizer and the like may be further added to curable liquid crystal composition within a range not detracting from the optical performance of the film.

The materials preferably contained in the curable liquid crystal composition are described below.

### (1) Polymerizable Rod-Shaped Liquid Crystal Compound:

One example of the rod-shaped liquid crystal compound usable in the invention is a rod-shaped nematic liquid crystal compound. Preferred examples of the rod-shaped nematic liquid crystal compound are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolanes and alkenylcyclohexylbenzonitriles. Not only low-molecular liquid crystal compounds but also high-molecular liquid crystal compounds are usable here.

The rod-shaped liquid crystal compound for use in the invention may be polymerizable or non-polymerizable. Rod-shaped liquid crystal compounds not having a polymerizable group are described in various references (for example, Y. Goto, et. al., Mol. Cryst. Liq. Cryst. 1995, Vol. 260, pp. 23-28).

The polymerizable rod-shaped liquid crystal compound may be obtained by introducing a polymerizable group into a rod-shaped liquid crystal compound. Examples of the polymerizable group include an unsaturated polymerizable group, an epoxy group and an aziridinyl group. Preferred is an unsaturated polymerizable group, and more preferred is an ethylenic unsaturated polymerizable group. The polymerizable group may be introduced into the molecule of a rod-shaped liquid crystal compound in various methods. The number of the polymerizable groups that the polymerizable rod-shaped liquid crystal compound has is preferably from 1 to 6, more preferably from 1 to 3. Examples of the polymerizable rod-shaped liquid crystal compound includes the compounds described in Makromol. Chem., Vol. 190, p. 2255 (1989); Advanced Materials, Vol. 5, p. 107 (1993); U.S. Pat. Nos. 4,683,327, 5,622,648, 5,770,107; WO95/22586, WO95/24455, WO97/00600, WO98/23580, WO98/52905; JP-A 1-272551, 6-16616, 7-110469, 11-80081, 2001-328973, etc. Two or more different types of polymerizable rod-shaped liquid crystal compounds may be used here as combined. When two or more different types of polymerizable rod-shaped liquid crystal compounds are used as combined, the alignment temperature may be lowered.

### (2) Alignment Controlling Agent:

An alignment controlling agent that contributes toward stable and rapid formation of the cholesteric liquid crystal phase may be added to the curable liquid crystal composition. Examples of the alignment controlling agent include compounds of the following general formulae (I) to (IV). Two or more of the compounds may be selected to be included. These compounds can reduce the tilt angle of the molecule of a liquid crystal compound or can align the molecule substantially horizontally in the interface of the layer to air. Further, the compounds of the following formulae (I) to (IV) are all excellent in diffusibility from lower layer to upper layer, and are therefore especially useful as the alignment controlling agent in the method of the invention.

In this description, “horizontal alignment” means that the long axis of a liquid crystal molecule is parallel to the film face, but does not require strict parallelness; and in this description, “horizontal alignment” means that the tilt angle to the horizontal face is less than 20 degrees. In case where a liquid crystal compound aligns horizontally near the interface to air, there may hardly occur alignment deficiency and therefore the transparency in the visible light region could increase and the reflectance in the IR region could also increase. On the other hand, when the molecules of liquid crystal compound align at a large tilt angle, then the helical axis of the cholesteric liquid crystal phase may shift from the normal line to the film face and the case is therefore unfavorable since the reflectance may lower, finger print patterns may occur and the haze may increase to exhibit refraction.

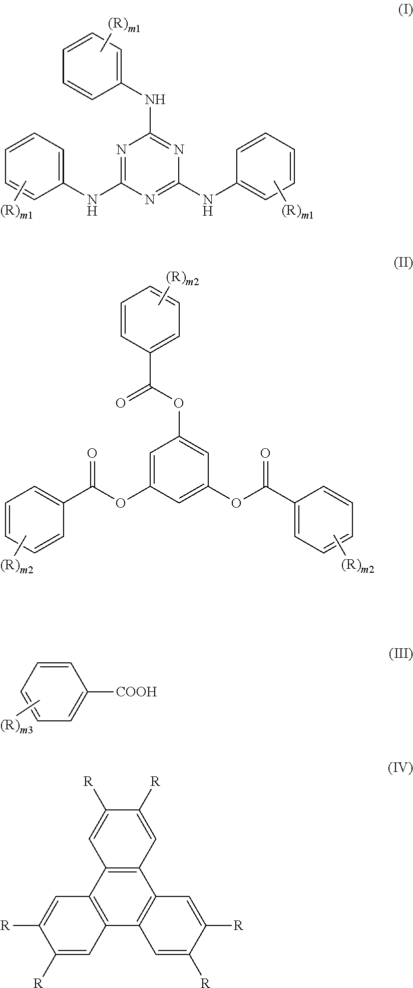

In the above formulae, R's may be the same or different, each representing an alkoxy group having from 1 to 30 carbon atoms and optionally substituted with a fluorine atom, preferably an alkoxy group having from 1 to 20 carbon atoms, more preferably an alkoxy group having from 1 to 15 carbon atoms. However, one or more CH₂'s in the alkoxy group or two or more CH₂'s not adjacent to each other therein may be substituted with —O—, —S—, —OCO—, —COO—, —NR^{a}—, —NR^{a}CO—, —CONR^{a}—, —NR^{a}SO₂—, or —SO₂NR^{a}—; and R^{a} represents a hydrogen atom or an alkyl group having from 1 to 5 carbon atoms. Preferably, the compound has at least one fluorine atom, since many molecules of the compound of the type may be distributed as eccentrically located in the interface to air and can be readily dissolved and diffused out into the upper layer. Preferably, the terminal carbon atom of the compound is substituted with a fluorine atom, and also preferably the compound has a perfluoroalkyl group at the terminal thereof.

Preferred examples of R are:

—OCₙH₂ₙ₊₁

—(OC₂H₄)ₙ₁(CF₂)ₙ₂F

—(OC₃H₆)ₙ₁(CF₂)ₙ₂F

—(OC₂H₄)ₙ₁NR^{a}SO₂(CF₂)ₙ₂F

—(OC₃H₆)ₙ₁NR^{a}SO₂(CF₂)ₙ₂F

In the above formulae, n, n1 and n2 each indicate an integer of 1 or more; n is preferably from 1 to 20, more preferably from 5 to 15; n1 is preferably from 1 to 10, more preferably from 1 to 5; n2 is preferably from 1 to 10, more preferably from 2 to 10.

In the above formulae, m1, m2 and m3 each indicate an integer of 1 or more.

Preferably, m1 is 1 or 2, more preferably 2. When m1 is 1, R is preferably para-positioned, and when 2, R is preferably meta- and para-positioned.

Preferably, m2 is 1 or 2, more preferably 1. When m2 is 1, R is preferably para-positioned, and when 2, R is preferably meta- and para-positioned.

Preferably, m3 is from 1 to 3, and more preferably, R is at two meta positions and at one para-position relative to —COOH.

Examples of the compounds of the above-mentioned formula (I) include the compounds shown in [0092] and [0093] in JP-A 2005-99248.

Examples of the compounds of the formula (II) include the compounds shown in [0076] to [0078] and [0082] to [0085] in JP-A 2002-129162.

Examples of the compounds of the formula (III) include the compounds shown in [0094] and [0095] in JP-A 2005-99248.

Examples of the compounds of the formula (IV) include the compounds shown in [0096] in JP-A 2005-99248.

The amount of the alignment controlling agent to be in the curable liquid crystal composition is preferably from 0.01 to 10% by mass of the mass of the liquid crystal compound therein, more preferably from 0.02 to 1% by mass.

### (3) Solvent:

The solvent in the curable liquid crystal composition is not specifically defined, for which any known solvent for liquid crystal compound is usable. The type of the solvent is not also specifically defined. For example, as the solvent, there may be mentioned ketones (acetone, 2-butanone, methyl isobutyl ketone, cyclohexanone, etc.); ethers (dioxane, tetrahydrofuran, etc.); aliphatic hydrocarbons (hexane, etc.); alicyclic hydrocarbons (cyclohexane, etc.); aromatic hydrocarbons (toluene, xylene, etc.); halogenohydrocarbons (dichloromethane, dichloroethane, etc.); esters (methyl acetate, ethyl acetate, butyl acetate, etc.); water; alcohols (ethanol, isopropanol, butanol, cyclohexanol, etc.); cellosolves (methyl cellosolve, ethyl cellosolve, etc.); cellosolve acetates; sulfoxides (dimethyl sulfoxide, etc.); amides (dimethylformamide, dimethylacetamide, etc.); etc. In the production method of the invention, use of 2-butanone is more preferred from the viewpoint of stability. On the other hand, for easy dissolution of the alignment controlling agent therein, a solvent having a high polarity may also be sued. Concretely, toluene, methyl ethyl ketone, N-methylpyrrolidone or the like is preferred for the case. One or more such solvents may be used here either singly or as combined.

From the viewpoint of the coating film formability and the production efficiency, the solid concentration in the curable liquid crystal composition is preferably from 10 to 50%, more preferably from 15 to 40%.

### (4) Optically-Active Compound (Chiral Agent):

The curable liquid crystal composition exhibits a cholesteric liquid crystal phase, for which the composition preferably contains an optically-active compound. However, in case where the rod-shaped liquid crystal compound is a molecule having an asymmetric carbon atom, there may be a case where the composition could stably form a cholesteric liquid crystal phase even though an optically-active compound is not added thereto. The optically-active compound may be selected from various known chiral agents (for example, as described in Liquid crystal Device Handbook, Chap. 3, Item 4-3, Chiral Agents for TN and STN, p. 199, by the 142nd Committee of the Japan Society for the Promotion of Science, 1989). The optically-active compound generally contains an asymmetric carbon atom; however, an axial asymmetric compound or a planar asymmetric compound not containing an asymmetric carbon atom may also be used here as the chiral agent. Examples of the axial asymmetric compound or the planar asymmetric compound include binaphthyl, helicene, paracyclophane and their derivatives. The optically-active compound (chiral agent) may have a polymerizable group. In case where the optically-active compound has a polymerizable group and the rod-shaped liquid crystal compound to be used concurrently also has a polymerizable group, a polymer may be formed through polymerization of the polymerizable optically-active compound and the polymerizable rod-shaped liquid crystal compound, which has a recurring unit derived from the rod-shaped liquid crystal compound and a recurring unit derived from the optically-active compound. In this embodiment, preferably, the polymerizable group which the polymerizable optically-active compound is a group of the same type as that of the polymerizable group which the polymerizable rod-shaped liquid crystal compound. Accordingly, preferably, the polymerizable group of the optically-active compound is also an unsaturated polymerizable group, an epoxy group or an aziridinyl group, more preferably an unsaturated polymerizable group, even more preferably an ethylenic unsaturated polymerizable group.

The optically-active compound may be a liquid crystal compound.

The amount of the optically-active compound in the curable liquid crystal composition is preferably from 1 to 30 mol % of the liquid crystal compound therein. The amount of the optically-active compound in the composition is preferably smaller in order that the compound does not have any influence on the liquid crystallinity of the composition. Accordingly, the optically-active compound to be used as a chiral agent in the composition is preferably a compound having a strong torsion force in order that the compound could attain the desired helical pitch torsion alignment even though its amount used is small. As the chiral agent having such a strong torsion force, for example, there may be mentioned the chiral agents described in JP-A 2003-287623, and these are favorably used also in the invention.

### (5) Polymerization Initiator:

The curable liquid crystal composition for forming the light reflective layer is preferably a polymerizable liquid crystal composition, for which, therefore, the composition preferably contains a polymerization initiator. One embodiment of the polymerizable liquid crystal composition is a UV-curable liquid crystal composition that contains a photopolymerization initiator capable of initiating polymerization through irradiation with UV ray. Examples of the photopolymerization initiator include a-carbonyl compounds (as described in U.S. Pat. Nos. 2,367,661, 2,367,670), acyloin ethers (as described in U.S. Pat. No. 2,448,828), α-hydrocarbon-substituted aromatic acyloin compounds (as described in U.S. Pat. No. 2,722,512), polynuclear quinone compounds (as described in U.S. Pat. Nos. 3,046,127, 29517589), combination of triarylimidazole dimer and p-aminophenyl ketone (as described in U.S. Pat. No. 3,549,367), acridine and phenazine compounds (as described in JP-A 60-105667, U.S. Pat. No. 4,239,850), oxadiazole compounds (as described in U.S. Pat. No. 4,212,970), etc.

The amount of the photopolymerization initiator to be used is preferably from 0.1 to 20% by mass of the curable liquid crystal composition (or the solid content of the coating liquid of the composition), more preferably from 1 to 8% by mass.

### (Preparation of Additive)

Preferably, the infrared light reflective film of the invention has a light reflective layer of such that the peak (maximum level) of the highest wavelength of the light to be reflected by it is at least 700 nm, or that is, a so-called IR-reflective layer, more preferably, the number of the peaks of the wavelength of the light to be reflected by the light reflective layer is at least one within a range of from 800 to 1300 nm. The selective reflectiveness to light having a wavelength of at least 700 nm is attained by the cholesteric liquid crystal phase having a helical pitch of generally from 500 to 1350 nm or so (preferably from 500 to 900 nm or so, more preferably from 550 to 800 nm or so, and having a thickness of generally from 1 μm to 8 μm or so (preferably from 3 to 8 μm or so).

The selective reflection wavelength of the light reflective layer is defined by the helical pitch, and the selective wavelength tends to shift toward the lower wavelength side when the incident direction of light is tilted from the normal line direction relative to the layer surface. Accordingly, for example, the helical pitch is first optimized relative to the introduction of light from the normal line direction, then the relationship between the incident angle and the shifting toward the shorter wavelength side of the selective reflection wavelength is confirmed through actual measurement, and the helical pitch may be computed from the measured data. The desired helical pitch to be computed in that manner can be attained by controlling at least one factor of the type of the chiral agent, the amount thereof and the polymerization reactivity.

Specifically, in the production method for an infrared light reflective film of the invention, a light reflective layer having a desired helical pitch can be formed by controlling the type and the concentration of the materials (mainly the liquid crystal material and the chiral agent) for use for forming the light reflective layer. The cholesteric liquid crystal phase having a desired optical rotation may be made by selecting the chiral agent or the liquid crystal material itself. The thickness of the layer may be made to fall within the desired range by controlling the coating amount.

### (Manufacture of Infrared Light Reflective Film)

It is preferable that the infrared light reflective film of the invention is further prepared by a coating method on the substrate having the dielectric multi-layered film formed thereon. An example of the manufacturing method is one including at least

(1) coating a curable liquid crystal composition on the surface of the dielectric multi-layered film of the substrate having the dielectric multi-layered film formed thereon, thereby converting it into a state of cholesteric liquid crystal phase; and

(2) irradiating the curable liquid crystal composition with ultraviolet rays to advance a curing reaction to immobilize the cholesteric liquid crystal phase therein, thereby forming a light reflective layer.

The steps (1) and (2) may be repeated arbitrary times, and by repeating these steps four times on the dielectric multi-layered film of the substrate having the dielectric multi-layered film formed thereon, an infrared light reflector having the same constitution as the constitution shown in FIG. 2 can be prepared.

In the step (1), first of all, the curable liquid crystal composition is coated on the surface of the dielectric multi-layered film of the substrate having the dielectric multi-layered film formed thereon. It is preferable that the curable liquid crystal composition is prepared as a coating liquid having materials dissolved and/or dispersed in a solvent. Coating of the coating liquid can be performed by various methods such as a wire bar coating method, an extrusion coating method, a direct gravure coating method, a reverse gravure coating method and a die coating method. Also, a coating film can be formed by discharging the liquid crystal composition from nozzles by using an inkjet apparatus.

Subsequently, the curable liquid crystal composition which has been coated on the surface and converted into a coating film is formed in a state of cholesteric liquid crystal phase. In an embodiment in which the curable liquid crystal composition is prepared as a coating liquid containing a solvent, there may be the case where it can be formed in a state of cholesteric liquid crystal phase by drying the coating film to remove the solvent. Also, in order to make a transition temperature into a cholesteric liquid crystal phase, if desired, the coating film may be heated. For example, the curable liquid crystal composition can be stably formed in a state of cholesteric liquid crystal phase by once heating to a temperature of an isotropic phase and thereafter cooling to a cholesteric liquid crystal phase transition temperature, or the like. From the standpoint of manufacturing adaptability or the like, the liquid crystal phase transition temperature of the curable liquid crystal composition is preferably within the range of from 10 to 250° C., and more preferably within the range of from 10 to 150° C. When the temperature is lower than 10° C., there may be the case where a cooling step or the like is required for the purpose of decreasing the temperature to a temperature range at which a liquid crystal phase is presented. Also, when the temperature is not higher than 200° C., a high temperature for forming an isotropic liquid state at a higher temperature than the temperature range in which the liquid crystal phase is once presented is not required, so that it is possible to prevent dissipation of thermal energy, deformation of a light transmitting support, degeneration or the like.

Subsequently, in the step (2), a curing reaction of the coating film which has been formed in a state of cholesteric liquid crystal phase is advanced. A method of advancing the curing reaction of the coating film which has been formed in a state of cholesteric liquid crystal phase is not particularly limited, but known methods can be adopted. Of these, a method of radiating ultraviolet rays can be preferably adopted.

For the irradiation with ultraviolet rays, alight source such as an ultraviolet lamp is utilized. In this step, by radiating ultraviolet rays, the curing reaction of the liquid crystal composition proceeds to immobilize the cholesteric liquid crystal phase, thereby forming a light reflective layer.

Though an irradiation energy amount of ultraviolet rays is not particularly limited, in general, it is preferably from about 100 mJ/cm² to 800 mJ/cm². Also, though a time of radiating the coating film with ultraviolet rays is not particularly limited, it may be determined from the viewpoints of both of sufficient strength and productivity of a cured film.

Also, though a wavelength of ultraviolet rays is not particularly limited, ultraviolet rays having a specified wavelength may be cut using an ultraviolet cutting filter or a resin film exhibiting an ultraviolet absorbing ability depending upon an application of the infrared light reflective film or intensity after curing required for the light reflective film.

In order to accelerate the curing reaction, irradiation with ultraviolet rays may be carried out under a heating condition. Also, in order that the cholesteric liquid crystal phase may not be disordered, it is preferable that the temperature at the irradiation with ultraviolet rays is kept within the temperature range in which a cholesteric liquid crystal phase is presented. Also, since an oxygen concentration of the atmosphere takes part in a degree of polymerization, in the case where a desired degree of polymerization is not attained in air, and the film strength is insufficient, it is preferable to lower the oxygen concentration in the atmosphere by a method such as substitution with nitrogen. The oxygen concentration is preferably not more than 10%, more preferably not more than 7%, and most preferably not more than 3%. From the viewpoint of keeping a mechanical strength of the layer, suppressing an outflow of unreacted materials from the layer, or the like, a rate of reaction of the curing reaction (for example, a polymerization reaction) which is advanced by irradiation with ultraviolet rays is preferably 70% or more, more preferably 80% or more, and still more preferably 90% or more. For the purpose of enhancing the rate of reaction, a method of increasing the irradiation amount of ultraviolet rays to be irradiated or polymerization under a nitrogen atmosphere or under a heating condition is effective. Also, after being once polymerized, a method of further going ahead with the reaction by a heat polymerization reaction while being kept in a higher temperature state than the polymerization temperature, or a method of again radiating ultraviolet rays (however, the ultraviolet rays are irradiated under a condition satisfying the condition of the invention) can be adopted. The measurement of the rate of reaction can be carried out by comparing an absorption strength of infrared vibration spectrum of a reactive group (for example, a polymerizable group) before and after progress of the reaction.

In the foregoing step, the cholesteric liquid crystal phase is immobilized, whereby the light reflective layer is formed. Here, with respect to the state in which the liquid crystal phase is “immobilized”, a state in which alignment of the liquid crystal compound having been formed into a cholesteric liquid crystal phase is kept is the most typical and preferred mode. However, it should not be construed that the invention is limited thereto. Specifically, it means a state in which in the temperature range of usually from 0° C. to 50° C., and more severely under a condition of from −30° C. to 70° C., the layer does not have fluidity, a change is not caused in the aligned state by an external field or an external force, and the immobilized aligned state can be continuously kept stably. In the invention, the aligned state of the cholesteric liquid crystal phase is immobilized by the curing reaction which is advanced by irradiation with ultraviolet rays.

Incidentally, in the infrared light reflective film of the invention, it may be sufficient so far as optical properties of the cholesteric liquid crystal phase are kept in the layer, but it is no longer required that the liquid crystal composition in the layer finally exhibits liquid crystallinity. For example, the liquid crystal composition no longer exhibits liquid crystallinity upon being polymerized by the curing reaction.

### (Relationship Between Plural Light Reflective Layers)

In the infrared reflective film of the invention, at least one layer of reflecting a right circularly-polarized light and at least one layer of reflecting a left circularly-polarized light are preferably formed. For example, this is described with reference to FIG. 1 and FIG. 2. For forming the light reflective layer 14b on the surface of the light reflective layer 14a, a curable liquid crystal composition is applied thereon. Like that for the light reflective layer 14a, the curable liquid crystal composition also contains a dextrorotatory or levorotatory chiral agent, and/or an asymmetric carbon atom-having liquid crystal material in order to exhibit a cholesteric liquid crystal phase. In particular, the composition preferably contains a chiral agent of which the direction of optical rotation differs from that of the chiral agent for use in forming the light reflective layer 14a. For example, in an embodiment where the liquid crystal composition for forming the light reflective layer 14a contains a dextrorotatory chiral agent, the composition for the layer 14b preferably contains a levorotatory chiral agent; and in an embodiment where the liquid crystal composition for forming the light reflective layer 14a contains a levorotatory chiral agent, the composition for the layer 14b preferably contains a dextrorotatory chiral agent.

Preferably, the layer of reflecting a right circularly-polarized light and the layer of reflecting a left circularly-polarized light are adjacent to each other. In this embodiment, the two light reflective layers both have a helical pitch on the same level and each have optical rotation in the direction opposite to each other. This embodiment is preferred as being capable of reflecting any of left and right circularly-polarized light having a wavelength on the same level. For example, there may be mentioned an example of this embodiment where one light reflective layer is formed of a curable liquid crystal composition containing a dextrorotatory chiral agent and the other light reflective layer is formed of a curable liquid crystal composition containing a levorotatory chiral agent, and the helical pitch of these light reflective layer is on the same level. In case where the film has at least two pairs of the neighboring two light reflective layers of those types and where the pairs differ in point of the helical pitch of the constitutive layer, the wavelength band of the light to be reflected may be broadened and the film could exhibit broadband light reflectivity.

### <Base Material>

It is preferable that the infrared light reflective film of the invention has a base material substrate. However, the substrate is not limited at all with respect to a material and optical characteristics so far as it is self-supporting and is able to support the light reflective layer. The base material will be required to have high transparency against an ultraviolet light depending upon an application. The base material may be a special retardation plate such as a λ/2 plate, which is manufactured by controlling the manufacturing process so as to satisfy prescribed optical characteristics, or may be a polymer film which has a large scattering of in-plane retardation, specifically when expressed in terms of a scattering in-plane retardation Re (1000) at a wavelength of 1,000 nm, the scattering of Re (1000) is 20 nm or more, or 100 nm or more, and which cannot be used as a prescribed retardation plate, or the like. Also, the in-plane retardation is not particularly limited, and for example, a retardation plate having an in-plane retardation Re (1000) at a wavelength of 1,000 nm of from 800 to 1,300 nm, or the like can be used. Also, the base material may be a glass. In the infrared light reflective film of the invention, it is preferable that the base material is a glass substrate.

Examples of the polymer film having high transmission properties against a visible light include various polymer films for optical film, which are used as a member of a display device of a liquid crystal display device. Examples of the substrate include a polyester film such as polyethylene terephthalate (PET), polybutylene terephthalate and polyethylene naphthalate (PEN); a polycarbonate (PC) film; a polymethyl methacrylate film; a polyolefin film such as polyethylene and polypropylene; a polyimide film; and a triacetyl cellulose (TAC) film. Of these, polyethylene terephthalate or triacetyl cellulose is preferable.

### <Characteristics of Infrared Light Reflective Film>

The infrared light reflective film of the invention has the following characteristics.

### (Reflection Wavelength Band of the Whole of Infrared Light Reflective Film)

In the infrared light reflective film of the invention, a wavelength of infrared rays to be reflected by the dielectric multi-layered film and the cholesteric liquid crystal-containing infrared light reflective layer includes the range of preferably from 800 nm to 1,800 nm, more preferably from 850 nm to 1,700 nm, and especially preferably from 900 nm to 1,650 nm. However, infrared rays having a wavelength of 750 nm or more may be reflected depending upon the required performance.

Furthermore, it is more preferable that the infrared light reflective film of the invention is also able to reflect ultraviolet rays by the dielectric multi-layered film. Specifically, a wavelength of ultraviolet rays which are reflected by the dielectric multi-layered film and the cholesteric liquid crystal-containing infrared light reflective layer includes the range of preferably not more than 400 nm, and more preferably not more than 380 nm.

### (Visible Light Transmittance)

A visible light transmittance of the infrared light reflective film of the invention is preferably 70% or more, more preferably 75% or more, and especially preferably 80% or more.

### (Radio Wave Transmittance)

A surface resistivity of the infrared light reflective film of the invention is preferably 1.0×10¹²Ω/□ or more, more preferably 5.0×10¹²Ω/□ or more, and especially preferably 9.0×10¹²Ω/□ or more. Since the infrared light reflective film of the invention does not contain a metal film, it is high in surface resistivity and also high in radio wave transmission properties.

### (Total Thickness)

Also, though a total thickness of the light reflective laminated film is not particularly limited, in a mode in which the light reflective laminated film includes four or more layers of a layer having a cholesteric liquid crystal phase immobilized therein and exhibits a light reflecting characteristic widely in an infrared reflection region, namely heat shielding properties, a thickness of each layer is from about 3 to 6 μm, and in general, a total thickness d₃ of the light reflective laminated film will be from about 15 to 40 μm.

In the infrared light reflective film of the invention, a total film thickness of the dielectric multi-layered film and the cholesteric liquid crystal-containing infrared light reflective layer is preferably from 10 to 60 μm, more preferably from 20 to 40 μm, and especially preferably from 25 to 35 μm.

### (Mode)

The infrared light reflective film of the invention may be a self-supporting member which can be utilized by itself as, for example, a window material, or may be a member which is not self-supporting itself but is used upon being stuck to a substrate such as a self-supporting glass plate. Also, the mode of the infrared light reflective film of the invention may be a mode in which it is spread in a sheet form, or may be a mode in which it is wound up in a roll form.

### (Use)

The use of the infrared light reflective film of the invention is not specifically defined.

In using it, the infrared light reflective reflective film of the invention may be stuck to the surface of a glass plate, a plastic substrate or the like. In this embodiment, the surface of the heat-shielding member to be stuck to a glass plate or the like is preferably adhesive. In this embodiment, preferably, the infrared light reflective film of the invention has an adhesive layer, an easy adhesion layer or the like capable of being stuck to the surface of the substrate such as a glass plate or the like. Needless-to-say, the infrared light reflective film of the invention that is not adhesive may be stuck to the surface of the glass plate using an adhesive therebetween.

Preferably, the infrared light reflective film of the invention has heat shieldability against sunlight, and more preferably, the film can well reflect the IR ray of 700 nm or more of sunlight.

The infrared light reflective film of the invention can be used as a heat-shielding windowpane of itself for vehicles or buildings, or as a sheet or a film to be stuck to the windowpanes of vehicles or buildings for the purpose of imparting heat shieldability thereto. In addition, the film may also be used for freezer showcases, materials for plastic greenhouses for agricultural use, reflective sheets for agricultural use, films for solar cells, etc. Among them, the infrared light reflective film of the invention is favorably used as an infrared light reflective film to be stuck to windowpanes, from the viewpoint of the characteristics of high visible light transmittance and low haze thereof.

Also, the infrared light reflective film of the invention may have a non-light reflective layer containing an organic material and/or an inorganic material. Examples of the non-light reflective layer which can be utilized in the invention include an easily adhesive layer for making it easy to adhere to other member (for example, an intermediate sheet, etc.). It is preferable that the easily adhesive layer is disposed as one or both outermost layers. For example, in a mode in which at least four cholesteric liquid crystal-containing infrared light reflective layers are disposed on one surface of the substrate, the easily adhesive layer can be disposed on the outermost infrared light reflective layer. And/or, the easily adhesive layer can also be disposed on the back surface of the substrate (surface of the substrate on the side on which the infrared light reflective layer is not disposed). A material which is utilized for the formation of the easily adhesive layer is selected among various materials depending upon whether the easily adhesive layer is formed adjacent to the infrared light reflective layer or adjacent to the substrate, or according to a material quality of other member to be adhered. Also, other examples of the non-light reflective layer which can be utilized in the invention include an undercoating layer for enhancing an adhesion between the infrared light reflective layer of a cholesteric liquid crystal phase and the substrate; and an aligned layer for precisely specifying an alignment direction of the liquid crystal compound, which is utilized in forming the infrared light reflective layer. It is preferable that the undercoating layer and the aligned layer are disposed between the at least one light reflective layer and the substrate. Also, the aligned layer may be disposed between the infrared light reflective layers.

In the case of utilizing the infrared light reflective film of the invention for a laminated glass, an easily adhesive layer containing a polyvinyl butyral resin may be included as at least one outermost layer. In general, the laminated glass is prepared by heat bonding an intermediate film formed on the inner surfaces of two glass plates. In the case where a laminate having a light reflective layer formed by immobilizing one or two or more layers of a cholesteric liquid crystal phase is interposed in the inside of this laminated glass, the surface of the light reflective layer is heat bonded to the intermediate film. However, since an adhesion therebetween is insufficient, when exposed to a natural light for a long period of time, thereby causing an elevation of the temperature, air bubbles are generated between the light reflective layer and the intermediate film, whereby transparency is lowered. When the easily adhesive layer is formed on the outermost layer of the infrared light reflective film of the invention, on the occasion of interposing the laminate between glass plates, the surface of the easily adhesive layer may be subjected to heat bonding to the intermediate film, whereby the adhesion is improved, and the light resistance is improved in its turn.

### EXAMPLES

The characteristic features of the invention are hereunder specifically described by reference to the following Examples and Comparative Examples (the Comparative Examples are not always concerned with a convention technology). Materials, use amounts, proportions, treatment contents, treatment procedures and so on shown in the following Examples can be properly changed so far as the gist of the invention is not deviated. In consequence, it should not be construed that the scope of the invention is restrictedly interpreted by the following specific examples.

### Manufacturing Example 1

### Preparation of Coating Liquid for Infrared Light Reflective Layer of Cholesteric Liquid Crystal Phase

### Liquid Crystal Composition-Containing Coating Liquid

Liquid crystal composition-containing coating liquids (R1) and (L1) each having the following composition were prepared, respectively.

TABLE 1
Composition table of coating liquid (R1)

| | Material name | |
|---|---|---|
| Material (kind) | (manufacturer) | Prescription amount |
| Rod-shaped liquid | RM-257 (Merck) | 10.000 parts by mass |
| crystalline | | |
| compound | | |
| Chiral agent | LC-756 (BASF) | 0.166 parts by mass |
| Polymerization | Irgacure 819 | 0.419 parts by mass |
| initiator | (Ciba Specialty | |
| | Chemicals) | |
| Alignment | Compound 1 shown | 0.016 parts by mass |
| controlling agent | below | |
| Solvent | 2-Butanone | 15.652 parts by mass |
| | (Wako Pure | |
| | Chemical) | |

TABLE 2
Composition table of coating liquid (L1)

| | Material name | |
|---|---|---|
| Material (kind) | (manufacturer) | Prescription amount |
| Rod-shaped liquid | RM-257 (Merck) | 10.000 parts by mass |
| crystalline | | |
| compound | | |
| Chiral agent | Compound 2 shown | 0.105 parts by mass |
| | below | |
| Polymerization | Irgacure 819 | 0.419 parts by mass |
| initiator | (Ciba Specialty | |
| | Chemicals) | |
| Alignment | Compound 1 shown | 0.016 parts by mass |
| controlling agent | below | |
| Solvent | 2-Butanone | 15.652 parts by mass |
| | (Wako Pure | |
| | Chemical) | |

Alignment Controlling Agent: Compound 1 (compound disclosed in JP-A 2005-99248)

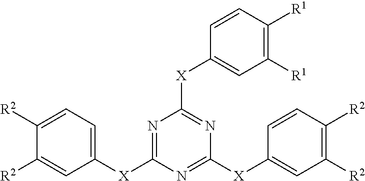

Chiral Agent: Compound 2 (compound disclosed in JP 2002-179668)

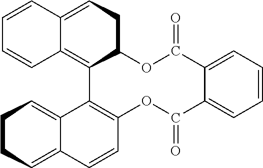

### Manufacturing Examples 2 to 7

Also, liquid crystal composition-containing coating liquids (R2) to (R7) were prepared in the same manner, except that the prescription amount of the chiral agent LC-756 in the liquid crystal composition-containing coating liquid (R1) was changed to an amount shown in the following table.

TABLE 3
Prescription amount of LC-756 of coating liquids (R2) to (R7)

| | Prescription amount of |
|---|---|
| | LC-756 |
| Coating liquid | (parts by mass) |
| Coating liquid (R2) | 0.143 |
| Coating liquid (R3) | 0.155 |
| Coating liquid (R4) | 0.132 |
| Coating liquid (R5) | 0.177 |
| Coating liquid (R6) | 0.268 |
| Coating liquid (R7) | 0.245 |

Also, liquid crystal composition-containing coating liquids (L2) to (L7) were prepared in the same manner, except that the prescription amount of the chiral agent, Compound 2 in the liquid crystal composition-containing coating liquid (L1) was changed to an amount shown in the following table.

TABLE 4
Prescription amount of Compound 2 of coating liquids (R2) to (R7)

| | Prescription amount of |
|---|---|
| | Compound 2 |
| Coating liquid | (parts by mass) |
| Coating liquid (L2) | 0.091 |
| Coating liquid (L3) | 0.098 |
| Coating liquid (L4) | 0.084 |
| Coating liquid (L5) | 0.112 |
| Coating liquid (L6) | 0.167 |
| Coating liquid (L7) | 0.154 |

### Example 1

### 1. Film Formation of Dielectric Multi-Layered Film

A transparent soda-lime glass having a size of 1,000 mm×1,000 mm and a thickness of 2 mm, which was manufactured by a float method, was cleaned and dried, and then set in a sputtering film forming apparatus. Then, five layers of a dielectric film were laminated on the surface to form an infrared light reflective film. The dielectric films constituting the infrared light reflective film were formed by film formation of a high-refractive index dielectric layer, TiO₂ film (thickness: 105 nm); a low-refractive index dielectric layer, SiO₂ film (thickness: 175 nm); a high-refractive index dielectric layer, TiO₂ film (thickness: 105 nm); a low-refractive index dielectric layer, SiO₂ film (thickness: 175 nm); and a high-refractive index dielectric layer, TiO₂ film (thickness: 105 nm) in order from the glass surface. An electrical resistance of the laminated dielectric multi-layered film was measured, and as a result, it was found to be substantially infinite.

### 2. Lamination of Infrared Light Reflective Layer of Cholesteric Liquid Crystal Phase

An infrared light reflective film of Example 1 was prepared in the following procedures by using the prepared liquid crystal composition-containing coating liquids (R1), (L1), (R2) and (L2).

First of all, the foregoing infrared light reflective substrate having a dielectric multi-layered film constituted by laminating five layers of a dielectric film on a glass was used as a substrate.

(1) Each of the liquid crystal composition-containing coating liquids was coated on the dielectric film of the infrared light reflective substrate in a thickness of the film after drying of 6 μm at room temperature by using a wire bar.
(2) After drying at room temperature for 30 seconds to remove the solvent, the resultant was heated in an atmosphere at 125° C. for 2 minutes and then treated at 95° C. to form a cholesteric liquid crystal phase. Subsequently, the cholesteric liquid crystal phase was immobilized upon irradiation with UV at an output of 60% for from 6 to 12 seconds by an electrodeless lamp “D Bulb” (90 mW/cm), manufactured by Fusion UV Systems, Inc., thereby preparing a film (infrared light reflective layer of a cholesteric liquid crystal phase).
(3) After cooling to room temperature, the foregoing steps (1) and (2) were repeated on the light reflective layer as an under layer, thereby preparing an infrared light reflective film having a glass, a dielectric multi-layered film made of laminated five layers, and an infrared light reflective layer of a cholesteric liquid crystal phase made of laminated four layers in this order.

Incidentally, coating was carried out by using the respective liquid crystal composition-containing coating liquids (R1), (L1), (R2) and (L2) in order.

### Example 2

An infrared light reflective film of Example 2 was prepared in the same procedures as those in Example 1, except for using the prepared liquid crystal composition-containing coating liquids (R3), (L3), (R4) and (L4).

### Example 3

An infrared light reflective film of Example 3 was prepared in the same procedures as those in Example 1, except for using the prepared liquid crystal composition-containing coating liquids (R5), (L5), (R3) and (L3).

### Example 4

An infrared light reflective film of Example 4 was prepared in the same procedures as those in Example 1, except for using the prepared liquid crystal composition-containing coating liquids (R6), (L6), (R7) and (L7).

### Example 5

An infrared light reflective base film of Example 5 was prepared in the same procedures as those in Example 1, except that instead of laminating the five layers of a dielectric film, an Nb₂O₅ film (thickness: 115 nm), an SiO₂ film (thickness: 175 nm), an Nb₂O₅ film (thickness: 115 nm), an SiO₂ film (thickness: 175 nm), an Nb₂O₅ film (thickness: 115 nm), an SiO₂ film (thickness: 175 nm) and an Nb₂O₅ film (thickness: 115 nm) were laminated in order, thereby constituting a dielectric multi-layered film made of seven layers of a dielectric layer.

### Example 6

An infrared light reflective film of Example 6 was prepared in the same procedures as those in Example 5, except for using the prepared liquid crystal composition-containing coating liquids (R5), (L5), (R3) and (L3).

### Example 7

An infrared light reflective base film of Example 7 was prepared in the same procedures as those in Example 1, except that instead of laminating the five layers of a dielectric film, an Nb₂O₅ film (thickness: 125 nm), an SiO₂ film (thickness: 190 nm), an Nb₂O₅ film (thickness: 125 nm), an SiO₂ film (thickness: 190 nm), an Nb₂O₅ film (thickness: 125 nm), an SiO₂ film (thickness: 190 nm) and an Nb₂O₅ film (thickness: 125 nm) were laminated in order, thereby constituting a dielectric multi-layered film made of seven layers of a dielectric layer.

### Example 8

An infrared light reflective base film of Example 8 was prepared in the same procedures as those in Example 2, except that instead of laminating the five layers of a dielectric film, an Nb₂O₅ film (thickness: 138 nm), an SiO₂ film (thickness: 210 nm), an Nb₂O₅ film (thickness: 138 nm), an SiO₂ film (thickness: 210 nm), an Nb₂O₅ film (thickness: 138 nm), an SiO₂ film (thickness: 210 nm) and an Nb₂O₅ film (thickness: 138 nm) were laminated in order, thereby constituting a dielectric multi-layered film made of seven layers of a dielectric layer.

### Example 9

An infrared light reflective base film of Example 9 was prepared in the same procedures as those in Example 1, except that the side on which the liquid crystal layer was coated was changed to an opposite side of the infrared light reflective substrate to the side on which the dielectric films were present.

### Comparative Example 1

An infrared light reflective base film of Comparative Example 1 was prepared in the same procedures as those in Example 1, except that instead of laminating the five layers of a dielectric film, a TiO₂ film (thickness: 70 nm), an SiO₂ film (thickness: 120 nm), a TiO₂ film (thickness: 70 nm), an SiO₂ film (thickness: 120 nm) and a TiO₂ film (thickness: 70 nm) were laminated in order, thereby constituting a dielectric multi-layered film made of five layers of a dielectric layer.

### Comparative Example 2

An infrared light reflective base film of Comparative Example 2 was prepared in the same procedures as those in Example 1, except that instead of laminating the five layers of a dielectric film, a TiO₂ film (thickness: 160 nm), an SiO₂ film (thickness: 260 nm), a TiO₂ film (thickness: 160 nm), an SiO₂ film (thickness: 260 nm) and a TiO₂ film (thickness: 160 nm) were laminated in order, thereby constituting a dielectric multi-layered film made of five layers of a dielectric layer.

### Comparative Example 3

An infrared light reflective base film of Comparative Example 3 was prepared in the same procedures as those in Example 1, except that instead of preparing the dielectric multi-layered film having five layers of a dielectric film laminated thereon, a tin-doped indium oxide layer was prepared in the same manner as that in Example 1 of JP-B-57-24524.

### Comparative Example 4

An infrared light reflective base film of Comparative Example 4 was prepared in the same procedures as those in Example 1, except that instead of laminating the five layers of a dielectric film, an SiO₂ film (thickness: 500 nm), an Ag film (thickness: 100 nm) and an SiO₂ film (thickness: 500 nm) were laminated in order, thereby constituting a dielectric multi-layered film made of three layers of a dielectric layer.

### Comparative Example 5

An infrared light reflective base film of Comparative Example 5 was prepared in the same procedures as those in Example 1, except that instead of using the infrared light reflective substrate having a dielectric multi-layered film constituted by laminating five layers of a dielectric film on glass, a film obtained by taking off an adhesive layer of NANO 90 (manufactured by 3M) as an organic multi-layered film was used.

### [Evaluation]

### (Visible Light Transmittance)

With respect to the infrared light reflective film prepared in each of the Examples and Comparative Examples, a visible light transmittance as stipulated in JIS R3106-1998 was measured.

The results are shown in the following Table 6.

### (Heat Shielding Performance)

With respect to the infrared light reflective film prepared in each of the Examples and Comparative Examples, a reflection spectrum was measured by a spectrophotometer “V-670”, manufactured by JASCO Corporation, and a heat shielding performance (reflectance) against a solar spectrum in the wavelength range of from 780 to 1,800 nm was calculated. The heat shielding performance was determined according to the following criteria (it is desirable that the reflectance is high).

A: The reflectance is 50% or more.

B: The reflectance is 40% or more and less than 50%.

C: The reflectance is less than 40%.

The results are shown in Table 6.

### (Ultraviolet Reflectance)

With respect to the infrared light reflective film prepared in each of the Examples and Comparative Examples, a reflection spectrum was measured by a spectrophotometer “V-670”, manufactured by JASCO Corporation, and a heat shielding performance (reflectance) against a solar spectrum in the wavelength range of from 300 to 380 nm was calculated. An ultraviolet reflectance was determined according to the following criteria (it is desirable that the reflectance is high).

A: The reflectance is 50% or more.

B: The reflectance is 40% or more and less than 50%.

C: The reflectance is less than 40%.

The results are shown in Table 6.

### (Light Resistance)

With respect to the infrared light reflective film prepared in each of the Examples and Comparative Examples, a light resistance test was carried out under the following condition, thereby visually evaluating a degree of yellowing. Incidentally, a BP temperature means a black panel temperature and refers to a temperature within a durability test apparatus.

Light Resistance Test Condition:

Apparatus: Light resistance tester, EYE Super UV (metal halide), manufactured by Iwasaki Electric Co., Ltd.

BP temperature: 63° C.

Irradiation surface: Glass surface (side on which neither a dielectric film nor a cholesteric liquid crystal layer is present)

Irradiation time: 200 hours

Determination of Yellowing:

A: No change occurs.

B: When precisely observed, yellowing is noted.

C: At the first glance, yellowing is noted.

D: Yellowing is seriously observed.

The results are shown in Table 6.

### (Radio Wave Transmission Properties)

With respect to the infrared light reflective film prepared in each of the Examples and Comparative Examples, a surface resistance (Ω/□) was measured by using a surface resistance analyzer (Loresta, manufactured by Mitsubishi Chemical Analytech Co., Ltd.) and evaluated as radio wave transmission properties.

The results are shown in Table 6.

TABLE 5

| | Material and | Material and | Number of laminations | | | | |
|---|---|---|---|---|---|---|---|
| | thickness of | thickness of | of dielectric film and | Cholesteric infrared light | | | Cholesteric infrared light |
| | low-refractive index | high-refractive index | reflection maximum | reflective layer (first layer) | Cholesteric infrared light | Cholesteric infrared light | reflective layer (fourth layer) |
| | dielectric layer | dielectric layer | wavelength | <Substrate side> | reflective layer (second layer) | reflective layer (third layer) | <Air interface side> |
| Example 1 | SiO₂ | TiO₂ | Five layers | Coating liquid (R1) | Coating liquid (L1) | Coating liquid (R2) | Coating liquid (L2) |
| | (thickness: 175 nm) | (thickness: 105 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Example 2 | SiO₂ | TiO₂ | Five layers | Coating liquid (R3) | Coating liquid (L3) | Coating liquid (R4) | Coating liquid (L4) |
| | (thickness: 175 nm) | (thickness: 105 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,600 nm | Central wavelength: 1,600 nm | Central wavelength: 1,700 nm | Central wavelength: 1,7000 nm |
| Example 3 | SiO₂ | TiO₂ | Five layers | Coating liquid (R5) | Coating liquid (L5) | Coating liquid (R3) | Coating liquid (L3) |
| | (thickness: 175 nm) | (thickness: 105 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,500 nm | Central wavelength: 1,500 nm | Central wavelength: 1,600 nm | Central wavelength: 1,600 nm |
| Example 4 | SiO₂ | TiO₂ | Five layers | Coating liquid (R6) | Coating liquid (L6) | Coating liquid (R7) | Coating liquid (L7) |
| | (thickness: 175 nm) | (thickness: 105 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,100 nm | Central wavelength: 1,100 nm | Central wavelength: 1,200 nm | Central wavelength: 1,200 nm |
| Example 5 | SiO₂ | Nb₂O₅ | Seven layers | Coating liquid (R1) | Coating liquid (L1) | Coating liquid (R2) | Coating liquid (L2) |
| | (thickness: 175 nm) | (thickness: 115 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Example 6 | SiO₂ | Nb₂O₅ | Seven layers | Coating liquid (R5) | Coating liquid (L5) | Coating liquid (R3) | Coating liquid (L3) |
| | (thickness: 175 nm) | (thickness: 115 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,500 nm | Central wavelength: 1,500 nm | Central wavelength: 1,600 nm | Central wavelength: 1,600 nm |
| Example 7 | SiO₂ | Nb₂O₅ | Seven layers | Coating liquid (R1) | Coating liquid (L1) | Coating liquid (R2) | Coating liquid (L2) |
| | (thickness: 190 nm) | (thickness: 125 nm) | Reflection maximum | Right circular polarization | Left circular polarization | Right circular polarization | Left circular polarization |
| | | | wavelength: 1,100 nm | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Example 8 | SiO₂ | Nb₂O₅ | Seven layers | Coating liquid (R3) | Coating liquid (L3) | Coating liquid (R4) | Coating liquid (L4) |
| | (thickness: 210 nm) | (thickness: 138 nm) | Reflection maximum | Right circular polarization | Left circular polarization | Right circular polarization | Left circular polarization |
| | | | wavelength: 1,200 nm | reflectivity | reflectivity | reflectivity | reflectivity |
| | | | | Central wavelength: 1,600 nm | Central wavelength: 1,600 nm | Central wavelength: 1,700 nm | Central wavelength: 1,700 nm |
| Example 9 | SiO₂ | TiO₂ | Five layers | Coating liquid (R1) | Coating liquid (L1) | Coating liquid (R2) | Coating liquid (L2) |
| | (thickness: 175 nm) | (thickness: 105 nm) | Reflection maximum | Right circular polarization | Left circular polarization | Right circular polarization | Left circular polarization |
| | | | wavelength: 1,000 nm | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Comparative | SiO₂ | TiO₂ | Five layers | Coating liquid (R1) | Coating liquid (L1) | Coating liquid (R2) | Coating liquid (L2) |
| Example 1 | (thickness: 120 nm) | (thickness: 70 nm) | Reflection maximum | Right circular polarization | Left circular polarization | Right circular polarization | Left circular polarization |
| | | | wavelength: 700 nm | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Comparative | SiO₂ | TiO₂ | Five layers | Coating liquid (R1) | Coating liquid (L1) | Coating liquid (R2) | Coating liquid (L2) |
| Example 2 | (thickness: 260 nm) | (thickness: 160 nm) | Reflection maximum | Right circular polarization | Left circular polarization | Right circular polarization | Left circular polarization |
| | | | wavelength: 1,500 nm | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Comparative | Tin-doped InO₂ | No | Single layer of | Coating liquid (R1) | Coating liquid (L1) | Coating liquid (R2) | Coating liquid (L2) |
| Example 3 | (thickness: 300 nm) | | low-refractive index | Right circular polarization | Left circular polarization | Right circular polarization | Left circular polarization |
| | | | dielectric | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Comparative | SiO₂ | Ag | Three layers including | Coating liquid (R1) | Coating liquid (L1) | Coating liquid (R2) | Coating liquid (L2) |
| Example 4 | (thickness: 500 nm) | (thickness: 100 nm) | metal film | Right circular polarization | Left circular polarization | Right circular polarization | Left circular polarization |
| | | | | reflectivity | reflectivity | reflectivity | reflectivity |
| | | | | Central wavelength: 1,550 nm | Central wavelength: 1,550 nm | Central wavelength: 1,650 nm | Central wavelength: 1,650 nm |
| Comparative | No | No | 200 layers made of | Coating liquid (R1) | Coating liquid (L1) | Coating liquid (R2) | Coating liquid (L2) |
| Example 5 | | | only organic film | Right circular polarization | Left circular polarization | Right circular polarization | Left circular polarization |
| | | | Reflection maximum | reflectivity | reflectivity | reflectivity | reflectivity |
| | | | wavelength: 1,000 nm | Central wavelength: 1,550 nm | Central wavelength: 1,550 nm | Central wavelength: 1,650 nm | Central wavelength: 1,650 nm |

TABLE 6

| | Wavelength of infrared | ni × di | ni × di | | Heat shielding | | | |
|---|---|---|---|---|---|---|---|---|
| | rays to be reflected by | of low-refractive | of high-refractive | | performance | | | Radio wave |
| | cholesteric infrared light | index dielectric | index dielectric | Visible light | (infrared | Ultraviolet | Light | transmission |
| | reflective layer | layer (nm) | layer (nm) | transmittance | reflectance) | reflectance | resistance | properties |
| Example 1 | 1,500 to 1,700 nm | 255 | 255 | 81% | 66% | 62% | A | 9.9 × 10¹² Ω/□ |
| | | | | (A) | (A) | (A) | | (A) |
| Example 2 | 1,550 to 1,750 nm | 255 | 255 | 80% | 64% | 62% | A | 9.9 × 10¹² Ω/□ |
| | | | | (A) | (A) | (A) | | (A) |
| Example 3 | 1,450 to 1,650 nm | 255 | 255 | 81% | 60% | 62% | A | 9.9 × 10¹² Ω/□ |
| | | | | (A) | (A) | (A) | | (A) |
| Example 4 | 1,050 to 1,250 nm | 255 | 255 | 80% | 44% | 62% | A | 9.9 × 10¹² Ω/□ |
| | | | | (A) | (B) | (A) | | (A) |
| Example 5 | 1,500 to 1,700 nm | 255 | 255 | 81% | 55% | 59% | A | 9.9 × 10¹² Ω/□ |
| | | | | (A) | (A) | (A) | | (A) |
| Example 6 | 1,450 to 1,650 nm | 255 | 255 | 80% | 57% | 59% | A | 9.9 × 10¹² Ω/□ |
| | | | | (A) | (A) | (A) | | (A) |
| Example 7 | 1,500 to 1,700 nm | 277 | 277 | 80% | 64% | 51% | A | 9.9 × 10¹² Ω/□ |
| | | | | (A) | (A) | (A) | | (A) |
| Example 8 | 1,550 to 1,750 nm | 306 | 306 | 77% | 58% | 40% | B | 9.9 × 10¹² Ω/□ |
| | | | | (A) | (A) | (B) | | (A) |
| Example 9 | 1,500 to 1,700 nm | 255 | 255 | 82% | 65% | 62% | A | 9.9 × 10¹² Ω/□ |
| | | | | (A) | (A) | (A) | | (A) |
| Comparative | 1,500 to 1,700 nm | 175 | 175 | 53% | 29% | 10% | C | 9.9 × 10¹² Ω/□ |
| Example 1 | | | | (C) | (C) | (C) | | (A) |
| Comparative | 1,500 to 1,700 nm | 375 | 375 | 43% | 49% | 41% | B | 9.9 × 10¹² Ω/□ |
| Example 2 | | | | (C) | (B) | (B) | | (A) |
| Comparative | 1,500 to 1,700 nm | — | — | 80% | 35% | 11% | D | 5.0 × 10² Ω/□ |
| Example 3 | | | | (A) | (C) | (C) | | (C) |
| Comparative | 1,500 to 1,700 nm | — | — | 79% | 49% | 10% | D | 6.0 Ω/□ |
| Example 4 | | | | (A) | (B) | (C) | | (C) |
| Comparative | 1,500 to 1,700 nm | — | — | 80% | 49% | 61% | D | 9.9 × 10¹² Ω/□ |
| Example 5 | | | | (A) | (B) | (A) | | (A) |

It was noted from Table 6 that the infrared light reflective film of the invention is high in all of visible light transmission properties, heat shielding performance, light resistance and radio wave transmission properties.

On the other hand, it was noted from Comparative Example 1 that when the value of ni×di of the low-refractive index dielectric layer and/or the high-refractive index dielectric layer of the dielectric multi-layered film is smaller than the lower limit value of the infrared light reflective film of the invention, the visible light transmittance and the light resistance are inferior to those of the invention. It was noted from Comparative Example 2 that when the value of ni×di of the low-refractive index dielectric layer and/or the high-refractive index dielectric layer of the dielectric multi-layered film is larger than the upper limit value of the infrared light reflective film of the invention, the visible light transmittance is inferior to that of the invention. It was noted from Comparative Example 3 that in the case of combining the single-layered low-refractive index dielectric layer with the infrared light reflective film of a cholesteric liquid crystal phase, the heat shielding performance, the light resistance and the radio wave transmission properties are inferior to those of the invention. It was noted from Comparative Example 4 that in the case of using a metal film as the high-refractive index dielectric layer of the dielectric multi-layered film, the light resistance and the radio wave transmission properties are inferior to those of the invention. It was noted from Comparative Example 5 that in the case of using an organic multi-layered film as the dielectric multi-layered film, the light resistance is inferior to that of the invention.

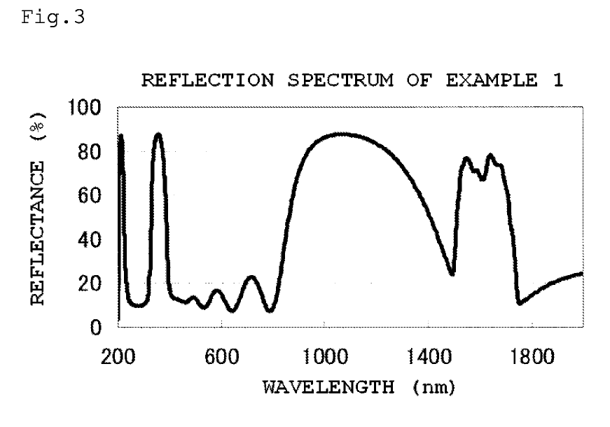

Furthermore, the reflection spectrum of the infrared light reflective film obtained in Example 1 was measured at a wavelength of from 200 to 2,000 nm by the same techniques as those in the measurement of heat shielding performance or ultraviolet reflectance. The results are shown in FIG. 3. It was noted from FIG. 3 that the infrared light reflective film of the invention is able to well reflect infrared rays and ultraviolet rays, while exhibiting favorable visible light transmission properties.

A reflection characteristic on the substrate glass surface of the infrared light reflective film obtained in Example 1 was examined. As a result, the infrared light reflective film obtained in Example 1 had a reflection characteristic of near infrared rays sufficient for exhibiting an effective heat shielding performance.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2010-169752, filed on Jul. 28, 2010, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. An infrared light reflective film comprising a dielectric multi-layered film constituted of an alternate laminate of a low-refractive index dielectric layer and a high-refractive index dielectric layer and a cholesteric liquid crystal-containing infrared light reflective layer, wherein all of the dielectric layers constituting the dielectric multi-layered film are composed of an inorganic material other than a metal, and all of the dielectric layers constituting the dielectric multi-layered film satisfy the following expression (1).
225 nm≦ni×di≦350 nm (1)
wherein ni represents a refractive index of an i-th dielectric layer of the dielectric multi-layered film; and di represents a thickness of an i-th dielectric layer of the dielectric multi-layered film.

2. The infrared light reflective film according to claim 1, wherein a wavelength of infrared rays to be reflected by the cholesteric liquid crystal-containing infrared light reflective layer includes the range of from 1,300 nm to 1,800 nm.

3. The infrared light reflective film according to claim 1, wherein the cholesteric liquid crystal-containing infrared light reflective layer contains four or more cholesteric liquid crystal layers.

4. The infrared light reflective film according to claim 1, wherein the dielectric layers constituting the dielectric multi-layered film are four or more layers.

5. The infrared light reflective film according to claim 1, wherein all of the dielectric films constituting the dielectric multi-layered film satisfy the following expression (2).
225 nm≦ni×di≦300 nm (2)
wherein ni represents a refractive index of an i-th dielectric layer of the dielectric multi-layered film; and di represents a thickness of an i-th dielectric layer of the dielectric multi-layered film.

6. The infrared light reflective film according to claim 1, wherein each of the dielectric layers constituting the dielectric film has a thickness of from 50 to 350 nm.

7. The infrared light reflective film according to claim 1, wherein each of the dielectric layers constituting the dielectric has a thickness of from 100 to 180 nm.

8. The infrared light reflective film according to claim 1, wherein a total film thickness of the dielectric multi-layered film and the cholesteric liquid crystal-containing infrared light reflective layer is from 20 to 40 μm.

9. The infrared light reflective film according to claim 1, wherein a wavelength of infrared rays to be reflected by the dielectric multi-layered film and the cholesteric liquid crystal-containing infrared light reflective layer includes the range of from 900 nm to 1,800 nm.

10. The infrared light reflective film according to claim 1, wherein the dielectric multi-layered film and the cholesteric liquid crystal-containing infrared light reflective layer are adjacent to each other.

11. The infrared light reflective film according to claim 1, wherein the dielectric multi-layered film is formed on a glass substrate.

12. The infrared light reflective film according to claim 1, wherein the dielectric multi-layered film is formed on a substrate and in the order of the low-refractive index layer and the high-refractive index layer from the substrate.

13. The infrared light reflective film according to claim 1, wherein the low-refractive index dielectric layer comprises at least one of SiO₂, MgF₂, Na₃AlF₆ and CaF₂.

14. The infrared light reflective film according to claim 1, wherein the low-refractive index dielectric layer comprises SiO₂.

15. The infrared light reflective film according to claim 1, wherein the high-refractive index dielectric layer comprises at least one of TiO₂, Nb₂O₅, Ta₂O₅, ZrO₂, ZnS and In₂O₃.

16. The infrared light reflective film according to claim 1, wherein the high-refractive index dielectric layer comprises at least one of TiO₂ or Nb₂O₅.

17. The infrared light reflective film according to claim 1, wherein the low-refractive index dielectric layer comprises SiO₂ and the high-refractive index dielectric layer comprises at least one of TiO₂ or Nb₂O₅.

18. The infrared light reflective film according to claim 1, wherein a visible light transmittance is 70% or more.

19. The infrared light reflective film according to claim 1, wherein a surface resistivity is 1.0×10¹²Ω/□ or more.

20. The infrared light reflective film according to claim 1, which is an infrared light reflective film adhered to window.
